(19) United States
(12) Patent Application Publication
(10) Pub. No.: US 2017/0316164 A1
(43) Pub. Date: Nov. 2, 2017

(54) METHOD AND DEVICE FOR ESTIMATING A CONDITION OF A PERSON

(71) Applicant: Stichting IMEC Nederland, Eindhoven (NL)

(72) Inventors: Pierluigi Casale, Waalre (NL); Ulf Grossekathoefer, Eindhoven (NL); Bishal Lamichhane, Eindhoven (NL)

(21) Appl. No.: 15/468,645

(22) Filed: Mar. 24, 2017

(30) Foreign Application Priority Data
Apr. 29, 2016 (EP) 16167619.2

(51) Int. Cl. G06F 19/00; G06N 99/00

(52) U.S. Cl. CPC G06F 19/345; G06N 99/005

(57) ABSTRACT

A method for estimating a condition of a person is disclosed. In one aspect, the method includes inputting a set of measurement values to an ensemble of machine learners. Each machine learner in the ensemble of machine learners is trained to make an estimate of the condition of the person based exclusively on features which are extracted from measurements by a single physiological sensor or environment sensor. The method further includes computing, by a machine learner in the ensemble of machine learners for which measurement values corresponding to the features used by the machine learner is available, an individual estimate value of the condition of the person, The method further includes receiving weights to be applied to the individual estimate values. The weights are at least partly adapted to individual characteristics of the person. The method further includes combining individual estimate values based on the received weights to make a final estimate of the condition of the person.

### RELATED APPLICATIONS

This application claims priority to European application no. EP 16167619.2, entitled “A METHOD AND DEVICE FOR ESTIMATING THE CONDITION OF A PERSON,” filed on Apr. 29, 2016, and incorporated herein by reference in its entirety.

### BACKGROUND

### Field

The disclosed technology relates to estimating a condition of a person, and particularly to estimating stress level of a person.

### Description of the Related Technology

There is growing worldwide awareness of the problems caused by long-term stress, such as depression, burn-out and cardiovascular disorders. The number of workdays lost due to anxiety, stress and neurotic disorders is four times higher than the number of lost days due to other non-fatal injuries and illnesses. In the European Union, more than 40 million individuals are affected by work-related stress. Stress is one of the most commonly reported causes of occupational illness by workers and costs approximately 20 billion euros per year in lost productivity and medical expenses, as reported in Institute of Work, Health & Organisations, “Towards the development of a European framework for psychosocial risk management at the workplace,” 2008.

Stress comes in many flavors and has many aspects. Biological stress describes the physiological reaction to stressors or threads. Psychological stress is related to psychological, social reactions and consequences caused by stress. Stress can lead to diseases that influence the ability to work, and affects the social environment such as the families of stressed persons. Biologically, stress is a strategy to address threatening situations and events in order to increase survival chances. For example, if an animal is confronted with an attack of a predator, stress triggers decision processes outside the usual channels, allows quicker reactions and, thus, increases the chances of survival.

Stress leads to various physiological responses in humans including increased adrenaline and cortisol levels, increased heart rate, dry mouth, dilated pupils, bladder relaxation, tunnel vision, shaking, flushed face, slowed digestion, hearing loss, and change in the electrical properties of the skin.

Stress and its physiological manifestation that can be measured by biosensors is a uniquely personal phenomenon. Each individual reacts differently to stress, and thus, the readings from biosensors are different. For example, for one individual, stress might manifest itself in a permanently increased heart rate, whereas another individual might show variation in electrodermal response. Such a wide variety of possible physiological responses makes it difficult to develop a generalized stress estimator that can predict the stress level of all persons. Instead, the estimator needs to be tailored to each individual.

Further, none of those physiological responses are exclusively caused by stress. Instead, there are various reasons that alter physiological signals in a similar way as stress does. Other events or situations not relating to stress can yield physiological responses similar to stress. For example, the heart rate increases also if a person performs physical demanding activities. The electrodermal properties of the skin are influenced by temperature and humidity of the surrounding air.

European patent no. EP 2 845 539 (A1) discloses a method for calculating normalized physiological signals of a living being. The method takes into consideration differences in physiology signals due to environmental factors, for example, by using a different model based on location information of the living being, and thus reducing differences within individuals due to environmental conditions. The method is capable of calculating a stress level from the normalized physiological signals.

However, combining multiple sensors to a multimodal sensor stream is prone to errors. For example, sensors might fail without notice due to hardware failures, or particular setups may only allow measurement of a subset of bio-signals that are present in the stress estimator. There is a need for a robust stress estimator that is able to address these issues without re-training or cost-intensive data collection and labeling.

### SUMMARY OF CERTAIN INVENTIVE ASPECTS

The disclosed technology includes a method and a device for estimating a condition of a person, which are robust and adapt to an individual, and incorporates contextual information. The device, method, and computer-readable media of the invention each have several aspects, no single one of which is solely responsible for its desirable attributes. Without limiting the scope of this invention, its more prominent features will now be briefly discussed.

A first aspect of the disclosed technology is a method for estimating a condition of a person. The method includes receiving a set of measurement values. The set of measurement values includes a plurality of physiological measurement values, applying to the condition of the person, and a plurality of context measurement values. The set of measurement values are obtained by a set of sensors including a plurality of physiological sensors and at least one environment sensor. Each physiological measurement value is obtained by a physiological sensor making a measurement on the person. Each context measurement value is obtained by an environment sensor making a measurement on an environment in which the person is located. The method further includes inputting the set of measurement values to an ensemble of machine learners for estimating the condition of the person. Each machine learner in the ensemble is trained to make an estimate of the condition of the person based exclusively on features which are extracted from measurements by a single physiological sensor or environment sensor. Each machine learner, depending on availability among the received set of measurement values, receives measurement values relevant to the features as input. The method further includes computing, by a machine learner in the ensemble for which measurement values corresponding to the features used by the machine learner is available, an individual estimate value of the condition of the person. The computing is performed by a plurality of machine learners to determine a plurality of individual estimate values. The method further includes receiving weights to be applied to the individual estimate values determined by the machine learners in the ensemble. The weights are at least partly adapted to individual characteristics of the person. The method further includes combining individual estimate values based on the received weights to make a final estimate of the condition of the person.

A second aspect is a non-transitory computer-readable medium storing instructions that when executed cause a processor to perform the method of the first aspect for estimating a condition of a person.

A third aspect is a device for estimating a condition of a person. The device includes a data input module configured to receive a set of measurement values. The set of measurement values includes a plurality of physiological measurement values, applying to the condition of the person, and a plurality of context measurement values. The set of measurement values are obtained by a set of sensors including a plurality of physiological sensors and a plurality of environment sensors. Each physiological measurement value is obtained by a physiological sensor making a measurement on the person. Each context measurement value is obtained by an environment sensor making a measurement on an environment in which the person is located. The device further includes a trained machine learning module, which includes an ensemble of machine learners for estimating the condition of the person. Each machine learner in the ensemble is trained to make an estimate of the condition of the person based exclusively on features which are extracted from measurements by a single physiological sensor or environment sensor. The trained machine learning module is configured to receive the set of measurement values from the data input module. Each machine learner, depending on availability among the received set of measurement values, receives measurement values relevant to the features as input. The trained machine learning module is further configured to compute, by a machine learner in the ensemble for which measurement values corresponding to the features used by the machine learner is available, an individual estimate value of the condition of the person. The computing is performed by a plurality of machine learners to determine a plurality of individual estimate values. The device further includes a combiner module configured to receive weights to be applied to the individual estimate values determined by the machine learners in the ensemble. The weights are at least partly adapted to individual characteristics of the person. The combiner module is further configured to combine individual estimate values based on the received weights to make a final estimate of the condition of the person.

According to the disclosed technology, each machine learner in an ensemble of machine learners for estimating a person's condition is trained to make an estimate of the condition based exclusively on features which are extracted from measurements by a single physiological sensor or environment sensor. This implies that if a sensor fails or is not available, machine learners which use input from other sensors are not affected at all. Hence, the estimation of the condition of a person may be very robust, as there is a possibility to fully use all machine learners that take input from the sensors that still function and are available.

Further, the relevance of measurements by a sensor may differ substantially for different persons, when, for example, a stress level is to be estimated. Thanks to machine learners being based exclusively on features extracted from measurements by a single sensor, the combining of individual estimate values from different machine learners may be easily personalized. Thus, the weight to be given to a machine learner being trained on measurements from a specific sensor may be adapted to individual characteristics reflecting the relevance of these measurements.

An ensemble of machine learners is normally used in machine learning to obtain better predictive performance than could be obtained from any constituent learning algorithm. According to the disclosed technology, each machine learner in the ensemble is trained on a single sensor modality, such that there is robustness to the possibility of making an estimate of the condition of a person.

The individual estimate values computed by machine learners in the ensemble need not be performed by all machine learners for which relevant measurement values are available. For a specific individual, a machine learner may not be relevant, even though measurement values are available. Then, instead of computing the individual estimate value and applying a zero weight to the individual estimate value, the individual estimate value need not be computed at all by the irrelevant machine learner.

The machine learners may be weak machine learners, which in combination in the ensemble are able to make a reliable estimate of the condition of the person.

According to an embodiment, the weights are at least partly based on a personal dataset for the person whose condition is to be estimated, the personal dataset relating measurement values obtained for the person to levels of the condition. Thus, the final estimate established by combined individual estimate values may be trained in relation to a personal dataset for a specific individual, such that the weights may be optimized for reliably estimating the condition for the individual.

According to another embodiment, the weights are at least partly based on information about weights in relation to characteristics of persons. For instance, anthropometric features, such as gender, age, body mass index, and behavior, may be collected during training of the ensemble of machine learners such that optimal weights in relation to the anthropometric features may be determined and stored in a database. Thus, the weights may be selected from the database such that, even if no training is performed for a specific individual weights that are likely to be relevant for the individual may be used.

According to an embodiment, the method further includes selecting machine learners that are relevant for estimating the condition for the person, wherein said computing is performed by the selected machine learners. Using relevance of machine learners for an individual, the machine learners that are relevant may be selected, such that individual estimate values need only be computed for the selected machine learners.

According to an embodiment, the method further includes detecting that no measurement values are received from a sensor among the set of sensors; and disregarding machine learners among the ensemble of machine learners that are trained to make an estimate of the condition of the person based on features which are extracted from measurements by the sensor from which no measurement values are received.

In case a sensor fails or is unavailable, some machine learners will not receive measurement to be able to make individual estimates of the condition. Therefore, these machine learners may be disregarded so as not to interfere with the final estimate of the condition. Further, thanks to each machine learner being trained based on features extracted from measurements by a single sensor, there will be other machine learners available so as to enable a final estimate of the condition to be determined.

According to an embodiment, the plurality of context measurement values in the set of measurement values are inputted to a weight selector for determining weights, wherein the weights are at least partly adapted to the environment in which the person is located. Hence, the weights to be used for individual estimate values may be adapted to a context in which the measurements are made. Thus, different weights may be given to individual estimate values depending on the context. For example, lesser weight may be given to an individual estimate value based on increased heart rate, if it simultaneously detected that the person is at a gym.

According to an embodiment, the method further includes determining a number of machine learners which are to contribute to a final estimate of the condition of the person; and adapting the received weights based at least on the determined number of machine learners for which individual estimate values are to contribute to the final prediction value. Thus, the method may re-normalize the weights to be used in dependence of how many machine learners are to contribute to the final estimate. The weights may initially be set in relation to using a combination based on individual estimate values from all machine learners. When some machine learners will no longer provide individual estimate values (because a sensor fails or is not available), the weights may be adapted to the actual machine learners to be used.

According to an embodiment, the condition is a stress level of the person. The method is especially suited for estimating a stress level, since many different sensor modalities may contribute to making a good prediction of the stress level and it may therefore be of interest to have a robust method which is able to reliably determine a stress level even if some sensor fails or is not available.

Other conditions may be estimated alternatively or additionally to estimation of a stress level, for which a plurality of sensors are used for obtaining data relevant for estimating the condition and, thus, there is a benefit of having robustness with regard to sensor failure or unavailability. For instance, a psychological state of the person may be estimated.

The method may also be used to estimate or monitor pain experienced by a person. This could be used, for instance, for a person recovering from a surgical operation, wherein sensor(s) may be arranged to be wearable, in order to detect and monitor pain of the person.

According to an embodiment, the set of measurement values include at least one in the group of: physiological measurement values from an electrocardiogram (ECG) sensor or a galvanic skin response (GSR) sensor and context measurement values from a light level sensor; or a positioning sensor. These types of measurement values may be relevant for estimating a stress level of a person. The ECG and GSR sensors may obtain physiological values which may be correlated to a stress level. Further, a position of the person may indicate a context which affects how the physiological measurement values are to be interpreted. For instance, if the person is at home, at work or at the gym, the physiological measurement values corresponding to an experienced stress may differ. Similarly, a light level in the environment may also affect the physiological measurement values such that the estimation of stress level needed to be adapted to the measured light level.

### BRIEF DESCRIPTION OF THE DRAWINGS

The objectives, features and advantages of the disclosed technology will be better understood through the following illustrative and non-limiting detailed description of embodiments of the disclosed technology, with reference to the appended drawings. In the drawings like reference numerals will be used for like elements unless stated otherwise.

FIG. 1 is a schematic view of a device for estimating a condition of a person according to an embodiment of the disclosed technology.

FIG. 2 is a schematic view of a relation between machine learners and sensors within the device.

FIG. 3 is a schematic view of a connection between a combiner module and databases for providing weight information.

FIG. 4 is a graph illustrating results from a study comparing classification accuracies for different weight configurations.

FIG. 5 is a flow chart of a method according to an embodiment of the disclosed technology.

### DETAILED DESCRIPTION OF CERTAIN ILLUSTRATIVE EMBODIMENTS

Detailed embodiments of the disclosed technology will now be described with reference to the drawings.

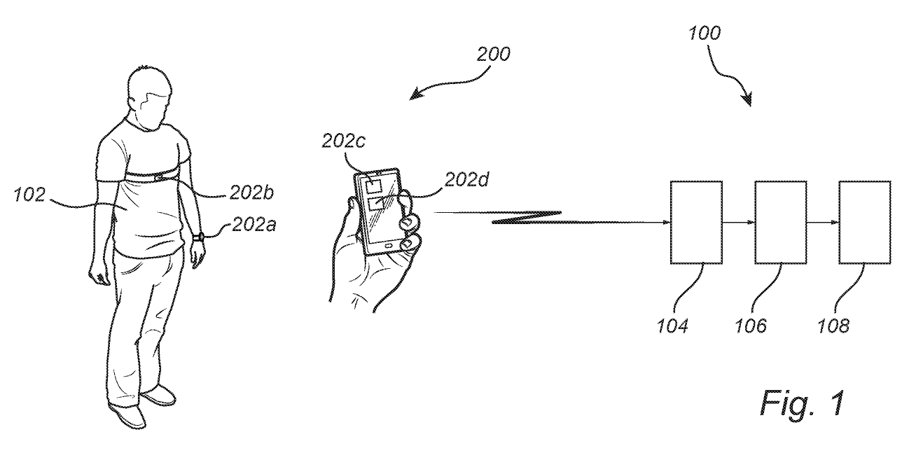

Referring to FIG. 1, a device 100 for estimating a condition of a person 102 will first be described. The device 100 may be arranged within a system 200, in which measurements for collecting data in order to determine an estimate of the condition are performed.

The system 200 may comprise a plurality of sensors 202a-d, including a plurality of physiological sensors 202a-b and a plurality of environment sensors 202c-d.

The physiological sensors 202a-b may be sensors which are arranged to obtain physiological measurement values. The physiological sensor 202a-b may, for instance, be arranged to acquire an electrocardiogram (ECG) or a galvanic skin response (GSR). The physiological sensors 202a-b may alternatively or additionally be arranged to acquire a simple heart rate (without acquiring an ECG), an electroencephalogram (EEG), a bioimpedance, body temperature, pulse oximetry, or other physiological measures.

The physiological sensor 202a-b may be arranged as a wearable sensor and may be continuously worn by the person 102. For instance, the physiological sensors 202a-b may be arranged in a garment, or may be arranged in a wearable device, such as a watch or a strap which is worn around the chest to measure heart information.

For example, a person 102 may be wearing such physiological sensors 202a-b anyway, as the physiological sensors 202a-b may e.g. be part of a smart watch.

The environment sensors 202c-d may be any sensors which are arranged to obtain measurements to provide a context of the person 102. The environment sensors 202c-d may, for instance, be arranged to acquire a position of the person, lighting conditions in the environment, a speed of movement of the person, sound, ambient temperature, humidity, or other environmental measures.

The environment sensors 202c-d may also be arranged as a wearable sensor and may be continuously worn by the person 102. The environment sensors 202c-d may alternatively be arranged in a portable device, such as a mobile phone, which the person 102 may be carrying most of the time. For instance, the environment sensors 202c-d may be a Global Positioning System (GPS) sensor, a light sensor, and/or an accelerometer, which may all be arranged in the mobile phone.

The physiological sensors 202a-b may be connected through wire or wirelessly to the device 100 for providing measurement values to the device 100. Similarly, the environment sensors 202c-d may be connected through wire or wirelessly to the device 100 for providing measurement values to the device 100.

In an embodiment, some or all of the physiological sensors 202a-b and/or the environment sensors 202c-d may be arranged within a common housing with the device 100. For instance, a mobile phone may be provided with software, such as an application, for performing computations so as to estimate the condition of the person 102.

The physiological sensors 202a-b and/or the environment sensors 202c-d may alternatively have a wired or wireless connection to an intermediate device and may provide measurement values to the intermediate device. The intermediate device may forward the measurement values to the device 100, such that the device 100 may be arranged in a server, which receives information from the intermediate device, for example, over a computer network, such as the Internet.

The device 100 may be implemented in hardware, or a combination of software and hardware. The device 100 may, for instance, be implemented as software being executed on a general-purpose computer, as firmware arranged, for example, in an embedded system, or as a specifically designed processing unit, such as an Application-Specific Integrated Circuit (ASIC) or a Field-Programmable Gate Array (FPGA). In a specific embodiment, the device 100 is arranged in a processing unit of a mobile phone a portable computing device such as a tablet, or a desktop computer, which is provided with a computer program for controlling the processing unit to perform a process for estimating a condition of the person 102.

The device 100 comprises a data input module 104, which is configured to receive a set of measurement values from the physiological sensors 202a-b and the environment sensors 202c-d. In an embodiment, the data input module 104 includes at least one circuit.

The device 100 further comprises a trained machine learning module 106, which is trained for estimating a condition of the person 102 based on measurement values, as will be further described below. The trained machine learning module 106 may comprise an ensemble of machine learners, and the machine learners may compute individual estimate values of the condition. In an embodiment, the machine learning module 106 is implemented as at least one circuit. In an embodiment, the machine learning module 106 is implemented on at least one processor. In an embodiment, software and/or firmware operates on the at least one processor or the at least one circuit. In an embodiment, the machine learning module accesses and/or includes a memory circuit.

The device 100 further comprises a combiner module 108, which is configured to receive weights to be applied to the individual estimate values and to combine the individual estimate values based on the received weights to make a final estimate of the condition. In an embodiment, the combiner module 108 includes at least one circuit. In an embodiment, the combiner module 108 is implemented as at least one circuit. In an embodiment, the combiner module 108 is implemented on at least one processor. In an embodiment, software and/or firmware operates on the at least one processor or the at least one circuit. In an embodiment, the combiner module 108 accesses and/or includes a memory circuit.

The device 100 is able to continuously and automatically update and recalculate the condition of a person 102 over time by gathering updated data from physiological measurements and updated information about the context the person 102 is in.

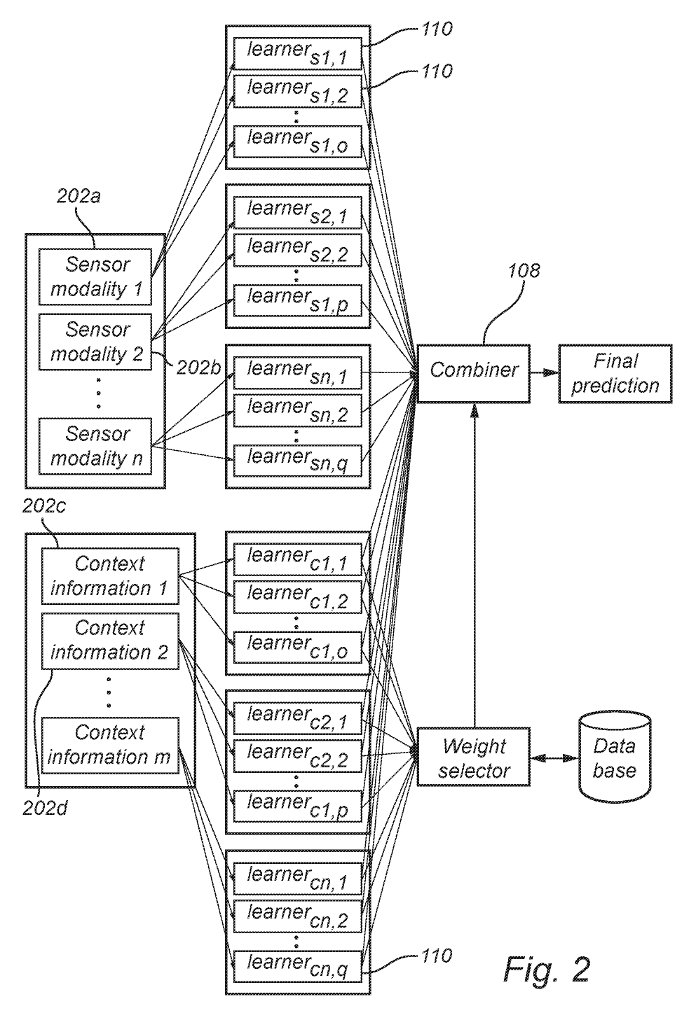

Referring now to FIG. 2, the estimation of a condition by the device 100 will be described in more detail. In the described device 100, a machine learner 110 uses a trained machine learning model implemented by a computing device. In an embodiment, the computing device includes at least one circuit, at least one processor and memory. In an embodiment, software and/or firmware operates on the at least one circuit and/or the at least one processor. Such a machine learning model could be, for example, a random forest, a support vector machine, a decision tree, a statistical classifier, a neural network, a correlator, a statistical estimator, a pattern classifier, or a pattern recognition system. The machine learners 110 are trained with a set of features all derived from a single sensor modality. Each machine learner 110 is trained on different subset of features for one single sensor or context modality, as indicated in FIG. 2, where each machine learner 110 receives input from only a single sensor 202a-d. In an embodiment, each machine learners 110 is trained using a pattern recognition technique.

The working of estimation of a condition of the person 102 is demonstrated with one representative example, wherein a stress level of the person 102 is to be estimated. Consider a system consisting of an ECG and a GSR sensor 202a-b measuring the physiology, and an ambient light sensor 202c and a microphone 202d measuring the context information.

A possible ECG 202a feature set could be:
i. Mean heart rate (mhr)
ii. Standard deviation of R-R peak intervals (sdnn)
iii. Root mean of sum of squared difference of consecutive R-R peak intervals (rmssd)
iv. Low frequency component of the spectrum of R-R peak intervals (LF): power in the 0.04 Hz-0.15 Hz band
v. High frequency component of the spectrum of R-R peak intervals (HF): power in the 0.15 Hz-0.4 Hz band
vi. Ratio of LF to HF (LFHF)
vii. Percentage of R-R peak intervals that are greater than 50 milliseconds (pnn50)
viii. Approximate entropy of R-R peak intervals (apen)
ix. Length of the major axis of Poincare plot (SD1)
x. Length off minor axis of Poincare plot (SD2)
xi. Ratio of the axes of Poincare plot (SD1/SD2)

A possible GSR sensor 202b feature set is:
i. Skin conductance level (scl)
ii. Signal power of the skin conductance signal (scp)
iii. Skin conductance response rate (scrr)
iv. Signal power in the second order difference of the skin conductance signal (scdiff2).

An example of a feature set from the measured sound signal through microphone 202d is:
i. Sound level (slevel)
ii. Dominant Frequency (Dfreq)
iii. Cepstral Coefficients (Ccoeff)
iv. Pitch-related features (Pfeat) e.g. pitch period and harmonics-to-noise ratio
v. Energy-related features (Efeat)
vi. Linear predictor coefficients (LPC)

An exemplary feature set computed from the measured ambient light sensor 202c is:
i. Mean light level (mlight)
ii. Variability of the light level (vlight)
iii. Median light level (medlight)
iv. Range of ambient light level (rangelight)

For example, in an embodiment the machine learners 110 are trained on following feature subsets: [{mhr, sdnn, rmssd}, {LF, HF, LFHF, apen}, {mhr, SD1, SD2, SD1SD2}, {rmssd, LF}, {scl, scp}, {scdiff2, scl, scp}, {Sieve′, Dfreq, Ccoeff}, {Ccoeff, Pfeat, Efeat}, {LPC, Pfeat, Efeat}, {mlight, vlight, medlight}, {rangelight, medlight, mlight}].

Each feature subset is strictly derived from a single sensor modality 202a-d. The described feature subset is just a representative example. One possible method to generate the feature subset from the available feature set is bootstrapping. Each of the machine learners 110, specializing in a feature subset for a modality, is capable to give a decision about the corresponding stress level against which the machine learners 110 have been trained. The machine learner 110 could be a classifier, which is able to predict for different discrete stress level (stress states) or a regression estimator (regressor), which is able to provide the prediction of stress level on a continuous scale.

The combiner module 108 produces a final decision on the stress level by combining the stress level reported by each of these machine learners 110. The combiner module 108 receives as input the estimated stress level from individual machine learners 110 on both physiological and contextual signal modalities. Within the combiner module 108 each of these decision channels are weighted and combined to produce a final decision.

A number of factors are considered in assigning the weights for these individual decision channels, which allows for personalization and contextualization of the estimation of the condition.

The combiner module 108 may receive information about anthropometric features of the person 102. Some examples of such anthropometric features are age, weight, behavior etc. These anthropometric features are cross-referenced with a database of information consisting of optimal weights computed for (a group of) individuals with their corresponding anthropometric features. The optimal weight for the person 102 in test is chosen according to the weights of the person/group in the database that is closest to the person 102 in test in the anthropometric feature space.

The combiner module 108 also has access to the information about the context for the person in test. This could for example be the person's location, such as work, house, gym, or shopping market. The combiner module 108 may thus take the context into account and an optimality of the weights is dependent on the context. The database may thus have further fine-grained detail about the optimal weights for various high level contexts.

The combiner module 108 may thus turn the final estimation of the condition into both personalized and contextualized estimation.

Further, the estimation is robust to sensor failures or differing sensor configuration. The system 200 for the person 102 in test could consist of only a subset of information signal modalities as compared to the information signal modality that was used for training the device 100. In such case, the device 100 is still able to produce an estimate of the condition. The machine learners 110 corresponding to a missing/faulty sensor modality is not able to produce any individual estimate values. However, the combiner module 108 may be aware of this and re-normalizes the weight configured for other decision channels.

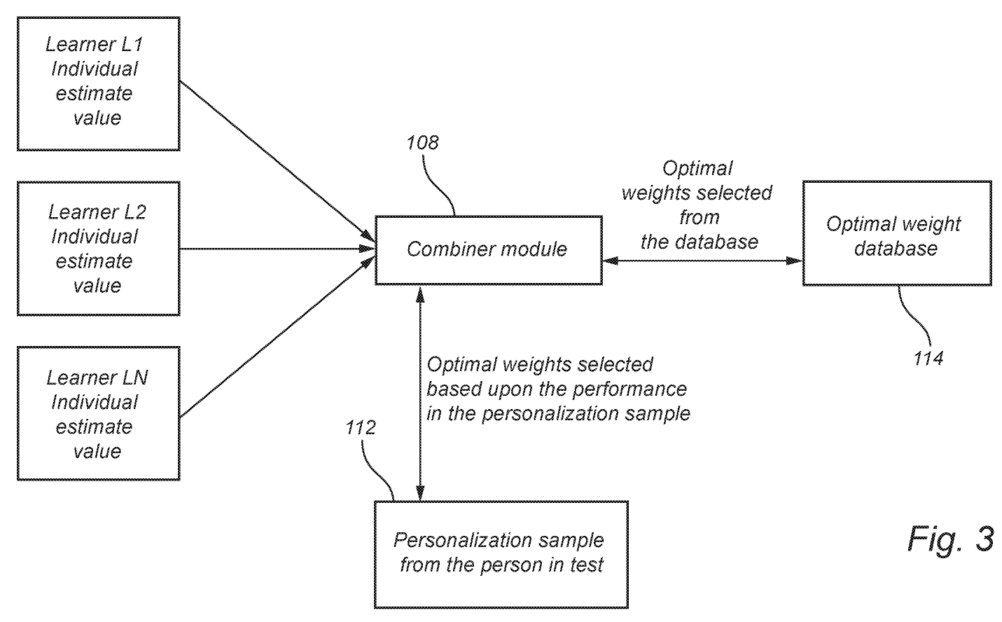

As illustrated in FIG. 3, the device 100 may be arranged in two different ways to enable personalization depending upon the availability of a personalization sample. Personalization sample is a small set of labeled dataset for the person 102 in test.

First, in the presence of a personalization sample, personalization works by learning the optimal weights, which gives good performance in the personalization sample. The combiner module 108 may thus retrieve weights to be used from a database 112, which stores weights based on the personalization sample.

Second, in the absence of a personalization sample, optimal weights are retrieved from the database 114 where the information about optimal weights for different (group of) person with a given anthropometric feature is stored.

A hybrid approach, in the presence of personalization sample, is also possible where the weights fit for the personalization sample in database 112 is fused with the weights drawn from the optimal weight database 114.

Stress response has a context factor. Stressors experienced at the workplace are different than the stressors present at home. There might be varying responses from a same individual based upon the context of the person 102 in test. Similarly, different individuals might show higher similarity of stress response in a similar context. For example, people working in same office environment are generally exposed to same kind of stressors. The combiner module 108 allows the possibility to take the context factors to stress response into account. This is embedded together with the personalization function.

Where personalization samples are available, the contextual factor may be included by optimizing the weights only on the subset of personalization samples specific or very close to a particular context. The weights are adapted with the personalization sample as the changing context of the person 102 in test is identified.

Where personalization samples are not available, the contextual factor is included based upon the pre-defined information available in the optimal weights database 114. The optimal weight database 114 has the optimal weights definition attached to the context within which it was derived.

In case a sensor or a sensor modality 202a-d fails or is not available due to, for example sensor failure or user behavior, the device 100 is able to provide a meaningful output based on the remaining sensors/sensor modalities 202a-d.

The individual estimate values of the remaining machine learners 110 reach the combiner module 108, where these values are fused while ignoring the missing values. This could be, for example, by dynamically setting the weight values of the machine learners 110 associated with missing modalities to zero, or by simply skipping over these individual estimate values in the combination process. In order to provide an identically distributed final output prediction from the combiner module 108, it might be necessary to re-normalize the weights that are associated with the single machine learners' estimates to a defined value, for example, one. The normalization will adjust the weights for the remaining machine learners 110 by the number of available machine learner predictions.

An example of pseudo code for weight adjustment to allow robust combination towards missing individual estimates of machine learners 110 is as follows:
normalization factor:=0
for weight_machine_learner_i in {available weights}:
   normalization factor:=normalization factor+weight_machine_learner_i for weight_machine_learner_i in {available weights}:
weight_machine_learner_i:=weight_machine_learner_i/normalization factor

An example of pseudo code for a combination operation in the combiner module 108 is as follows:
prediction_value:=0
for i in 1:num machine learners:
   prediction_value:=weight_machine_learner_i*prediction_machine_learner_i final_prediction:=prediction_value/num_machine_learners

An example of pseudo code for a combination operation in the combiner module 108 that only uses estimate values from available machine learners 110 is as follows:

```
prediction_value := 0
num_valid_machine_learners := 0
for i in 1:num_machine_learners:
  if prediction_machine_learner_i_is_available:
    prediction_value := weight_machine_learner_i*
      prediction_machine_learner_i
    num_valid_machine_learners := num_valid_machine_learners + 1
final_prediction := prediction_value / num_valid_machine_learners
```

An experiment has been performed to investigate if incorporating information about different group of people with a given anthropometric feature can be used to increase the estimation accuracy of self-reported stress levels. In order to answer this research question, random forest classifiers (machine learners) were evaluated for

(a) Data collected from a set of participants without incorporating anthropometric information (general machine learner).

(b) Data for only a subset of participants that share a common anthropometric feature. For demonstration purposes, the data from all female participants available in the study corpus (anthropometric machine learner) was selected.

These machine learners are then combined in an ensemble as suggested above. The weights were manually defined to

(a) General configuration: w_general=1, w_anthropometric=0.

(b) Anthropometric configuration: w_general=0, w_anthorpometric=1.

An out-of-bag error validation scheme was incorporated where data that is not used in training one tree from the random forest is used for testing.

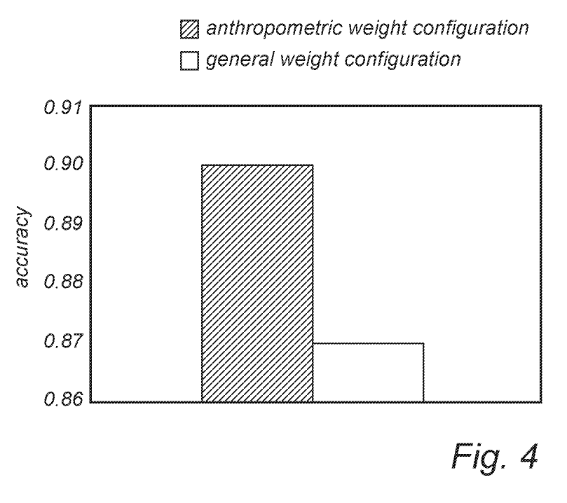

FIG. 4 illustrates the mean accuracy yielded for the general configuration as well as from the anthropometric configuration. In average, the general configuration reaches stress prediction accuracies of 87.03% while the anthropometric configuration reaches an average accuracy of 90%.

These results show that selecting specific weight configurations based on anthropometric features can increase the prediction capabilities of self-reported stress levels.

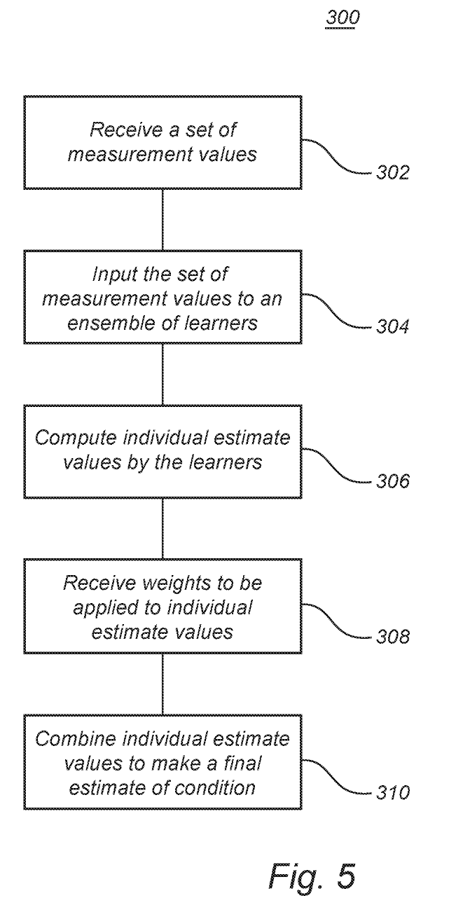

FIG. 5 illustrates a method 300 for estimating a condition of a person.

In block 302, method 300 receives a set of measurement values comprising a plurality of physiological measurement values and a plurality of context measurement values. The set of measurement values are obtained by a set of sensors comprising a plurality of physiological sensors and at least one environment sensor, wherein each physiological measurement value is obtained by a physiological sensor making a measurement on the person, and wherein each context measurement value is obtained by an environment sensor making a measurement on an environment in which the person is located. In an embodiment, at least some of the functions of block 302 are performed by data input module 104 receiving data sensed by sensors 202a, 202b, 202c and/or 202d of FIG. 1.

In block 304, method 300 inputs, to a trained machine learning module, the set of measurement values to an ensemble of machine learners. The machine learners which are relevant for estimating the condition of the person may be selected based, for example, on input of relevance of machine learners for the specific person. In an embodiment, at least some of the functions of block 304 are performed by machine language learning module 106 of FIG. 1, which includes the ensemble of machine learners 110 of FIG. 2.

Also, or alternatively, the trained machine learning module may detect that no measurement values are received from a sensor. If so, machine learners that are trained to make an estimate of the condition of the person based on features extracted from measurements by the sensor may be disregarded. For instance, the machine learner may not be addressed such that no estimate is computed by the machine learner.

In block 306, method 300 computes individual estimate values of the condition of the person based on the input measurement values. In an embodiment, at least some of the functions of block 306 are performed by machine language learning module 106 of FIG. 1, which includes the ensemble of machine learners 110 of FIG. 2.

The individual estimate values may be transferred to a combiner module. In block 308, the method 300 receives weights to be applied to the individual estimate values. The weights may be at least partly adapted to individual characteristics, such as anthropometric features, of the person for which a condition is estimated. The weights may also be adapted to a context the person is in. In an embodiment, the functions of block 308 are performed by machine language learning module 106 of FIG. 1, which includes the ensemble of machine learners 110 of FIG. 2. In an embodiment, the functions of block 308 are performed by at least some of combiner module 108 of FIGS. 1 and 2.

In block 310, method 300 combines the individual estimate values based on the received weights in order to make a final estimate or prediction of the condition of the person. In an embodiment, the functions of at least some of block 310 are performed the functions of block 310 are performed by combiner module 108 of FIGS. 1 and 2

In the above the invention has mainly been described with reference to a limited number of embodiments. However, as is readily appreciated by a person skilled in the art, other embodiments than the ones disclosed above are equally possible within the scope of the invention, as defined by the appended claims.

Those skilled in the art will further appreciate that the various illustrative logical blocks, modules, circuits, methods and algorithms described in connection with the examples disclosed herein may be implemented as electronic hardware, computer software, or combinations of both. To clearly illustrate this interchangeability of hardware and software, various illustrative components, blocks, modules, circuits, methods and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be connected to the processor such that the processor can read information from, and write information to, the storage medium. In the alternative, the storage medium may be integral to the processor. The processor and the storage medium may reside in an ASIC.

Depending on the embodiment, certain acts, events, or functions of any of the methods described herein can be performed in a different sequence, can be added, merged, or left out altogether (e.g., not all described acts or events are necessary for the practice of the method). Moreover, in certain embodiments, acts or events can be performed concurrently, rather than sequentially.

The previous description of the disclosed examples is provided to enable any person skilled in the art to make or use the present invention. Various modifications to these examples will be readily apparent to those skilled in the art, and the generic principles defined herein may be applied to other examples without departing from the spirit or scope of the invention. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope. Thus, the present invention is not intended to be limited to the examples shown herein but is to be accorded the widest scope consistent with the principles and novel features disclosed herein.

What is claimed is:

1. A method for estimating a condition of a person, comprising:
receiving a set of measurement values comprising a plurality of physiological measurement values and a plurality of context measurement values, wherein the set of measurement values are obtained by a set of sensors comprising a plurality of physiological sensors and at least one environment sensor, wherein each physiological measurement value is obtained by a physiological sensor making a measurement on the person, and wherein each context measurement value is obtained by an environment sensor making a measurement on an environment in which the person is located;
inputting the set of measurement values to an ensemble of machine learners for estimating the condition of the person, wherein each machine learner in the ensemble of machine learners is trained to make an estimate of the condition of the person based exclusively on features which are extracted from measurements by a single physiological sensor or environment sensor and wherein each machine learner, depending on availability among the received set of measurement values, receives measurement values relevant to the features as input;
computing, by a machine learner in the ensemble of machine learners for which measurement values corresponding to the features used by the machine learner is available, an individual estimate value of the condition of the person, wherein the computing is performed by a plurality of machine learners to determine a plurality of individual estimate values;
receiving weights to be applied to the individual estimate values determined by the machine learners in the ensemble of machine learners, wherein the weights are at least partly adapted to individual characteristics of the person; and
combining individual estimate values based on the received weights to make a final estimate of the condition of the person.

2. The method according to claim 1, wherein the weights are at least partly based on a personal dataset for the person whose condition is to be estimated, the personal dataset relating measurement values obtained for the person to levels of the condition of the person.

3. The method of claim 1, wherein the weights are at least partly based on a database storing information about weights in relation to characteristics of persons.

4. The method of claim 1, further comprising selecting machine learners that are relevant for estimating the condition for the person, wherein the computing is performed by the selected machine learners.

5. The method of claim 1, further comprising detecting that no measurement values are received from a sensor among the set of sensors; and disregarding machine learners among the ensemble of machine learners that are trained to make an estimate of the condition of the person based on features which are extracted from measurements by the sensor from which no measurement values are received.

6. The method of claim 1, wherein the plurality of context measurement values in the set of measurement values are inputted to a weight selector for determining weights, wherein the weights are at least partly adapted to the environment in which the person is located.

7. The method of claim 1, further comprising: determining a number of machine learners which are to contribute to a final estimate of the condition of the person; and adapting the received weights based at least on the determined number of machine learners for which individual estimate values are to contribute to the final prediction value.

8. The method of claim 1, wherein the condition is a stress level of the person.

9. The method of claim 8, wherein the set of measurement values comprises at least one in the group of:
physiological measurement values from an electrocardiogram (ECG) sensor;
physiological measurement values from a galvanic skin response (GSR) sensor;
context measurement values from a light level sensor; and
context measurement values from a positioning sensor.

10. A non-transitory computer-readable medium storing instructions that when executed cause a processor to perform the method of claim 1.

11. A device for estimating a condition of a person, the device comprising:
a data input module, which is configured to receive a set of measurement values, said set of measurement values comprising a plurality of physiological measurement values applying to the condition of the person and a plurality of context measurement values, wherein said set of measurement values are obtained by a set of sensors comprising a plurality of physiological sensors and a plurality of environment sensors, wherein each physiological measurement value is obtained by a physiological sensor making a measurement on the person and wherein each context measurement value is obtained by an environment sensor making a measurement on an environment in which the person is located;
a trained machine learning module which comprises an ensemble of machine learners for estimating the condition of the person, wherein each machine learner in the ensemble of machine learners is trained to make an estimate of the condition of the person based exclusively on features which are extracted from measurements by a single physiological sensor or environment sensor, wherein said trained machine learning module is configured to receive the set of measurement values from the data input module and wherein each machine learner, depending on availability among the received set of measurement values, receives measurement values relevant to the features as input;
said trained machine learning module being further configured to compute, by a machine learner in the ensemble of machine learners for which measurement values corresponding to the features used by the machine learner is available, an individual estimate value of the condition of the person, wherein said computing is performed by a plurality of machine learners to determine a plurality of individual estimate values; and
a combiner module, which is configured to receive weights to be applied to the individual estimate values determined by the machine learners in the ensemble of machine learners, wherein the weights are at least partly adapted to individual characteristics of the person; and
wherein the combiner module is further configured to combine individual estimate values based on the received weights to make a final estimate of the condition of the person.
